(19) United States
(12) Patent Application Publication
(10) Pub. No.: US 2006/0033725 A1
(43) Pub. Date: Feb. 16, 2006

(54) User created interactive interface

(75) Inventors: James Marggraff, Lafayette, CA (US); Alex Chisholm, San Francisco, CA (US); Tracy L. Edgecomb, Berkeley, CA (US); Nathaniel A. Fast, Santa Rosa, CA (US)

Correspondence Address: WAGNER, MURABITO & HAO, LLP, TWO NORTH MARKET STREET, THIRD FLOOR, SAN JOSE, CA, 95113, US

(73) Assignee: LeapFrog Enterprises, Inc., Emeryville, CA (US)

(21) Appl. No.: 10/861,243

(22) Filed: Jun. 3, 2004

(51) Int. Cl. G09G 5/00

(52) U.S. Cl. 345/179

(57) ABSTRACT

An interactive apparatus is disclosed. The interactive apparatus includes a stylus housing, a processor coupled to the stylus housing, and a memory unit comprising (i) computer code for recognizing a plurality of graphic elements created using a stylus, (ii) computer code for recognizing the selection of at least two of the graphic elements in a user defined sequence using the stylus, and (iii) computer code for playing at least one audio output that relates to the formed graphic elements, and an audio output device.

### BACKGROUND OF THE INVENTION

There are a number of systems that allow a user to obtain some feedback after selecting print elements on a print medium using a stylus.

One such system is described in Ohara et al. (U.S. Pat. No. 5,485,176). In this patent, a user uses a stylus and selects a print element in a book that is on a platform. The platform is connected to a video monitor. A visual output corresponding to the selected print element is displayed on the video monitor after the user selects the print element.

While the system described in Ohara et al. is useful, improvements could be made. For example, the system produces mainly visual outputs as opposed to audio outputs and has no writing capability.

Another system that allows a user to obtain feedback is called Scan-A-Page or Word™ from Brighteye Technology™. To the extent understood, the system uses a scanning stylus and optical character recognition software run by a personal computer to recognize printed words. After a word is scanned and it is recognized, the recognized words are read aloud by a synthesized voice. While this system is also useful, its interactive capability is limited. For example, it is limited to scanning print elements such as words and then listening to audio related to the print elements.

There are other problems with the above-identified systems. For example, neither of the above systems allows a user to create a user-defined application, or a user interactive system on a sheet of paper or other medium.

Embodiments of the invention address these and other problems.

### SUMMARY OF THE INVENTION

Embodiments of the invention allow a user to create user-defined applications on paper, and/or allow a user to interact with paper in a way that was not previously contemplated. For example, in some embodiments, a user can use an interactive stylus to create a user-defined user interface by creating graphic elements on a sheet of paper. The user may thereafter interact with the graphic elements in a way that is similar to how one might interact with a pen-based computer, except that the pen-based computer is not present. From the user's perspective, a lifeless piece of paper has been brought to life and is a functioning interface for the user.

One embodiment of the invention is directed to a method comprising: (a) creating a graphic element using a stylus; (b) listening to an audio recitation of at least one menu item in a plurality of menu items after creating the graphic element; and (c) selecting a menu item from the plurality of menu items.

Another embodiment of the invention is directed to an interactive apparatus comprising: a stylus housing; a processor; a memory unit comprising (i) computer code for recognizing a graphic element created by the user using the stylus, (ii) computer code for playing an audio recitation of at least one menu item in a plurality of menu items after the graphic element is created by the user, and (iii) computer code for recognizing a user selection of a menu item from the plurality of menu items; and an audio output device, wherein the audio output device and the memory unit are operatively coupled to the processor.

Another embodiment of the invention is directed to a method comprising: (a) forming a plurality of graphic elements using a stylus; (b) selecting at least two of the graphic elements in a user defined sequence using the stylus; and (c) listening to at least one audio output that relates to the formed graphic elements.

Another embodiment of the invention is directed to an interactive apparatus comprising: a stylus housing; a processor coupled to the stylus housing; a memory unit comprising (i) computer code for recognizing a plurality of graphic elements created using a stylus, (ii) computer code for recognizing the selection of at least two of the graphic elements in a user defined sequence using the stylus, and (iii) computer code for playing an audio output that relates to the formed graphic elements; and an audio output device, wherein the audio output device and the memory unit are operatively coupled to the processor.

These and other embodiments of the invention will be described in further detail below.

### BRIEF DESCRIPTION OF THE DRAWINGS

FIG. 1 shows a schematic drawing of an interactive system including a two-dimensional article and an interactive apparatus.

FIG. 2 shows a schematic drawing of an interactive system that includes a two-dimensional article and an interactive apparatus including a platform.

FIG. 3 shows a block diagram of some electronic components of an interactive apparatus according to an embodiment of the invention.

FIG. 4 shows a schematic diagram of a tree menu according to an embodiment of the invention.

FIG. 5 shows a flowchart illustrating a method according to an embodiment of the invention.

FIGS. 6(a)-6(c) show schematic illustrations of how a stylus can be used to create graphic elements and interact with them to cause the interactive apparatus to provide a list of menu items and to allow a user to select a menu item.

FIG. 7 shows a flowchart illustrating a method according to an embodiment of the invention.

FIG. 8 shows an embodiment of the invention where a user can write a plurality of numbers on a sheet of paper to produce a custom calculator.

FIGS. 9(a)-9(b) shows sheets illustrating how a translator can be produced on a sheet of paper.

FIG. 10(a) shows a sheet with circles on it where the circles are used in a game called “word scramble”.

FIG. 10(b) is a sheet with markings, which show how another translator and a dictionary may be used.

FIG. 11(a) is a sheet, which shows how an alarm clock function can be used.

FIG. 11(b) is a sheet, which shows how a phone list function can be used.

FIG. 12 shows a block diagram of a communication system according to an embodiment of the invention.

### DETAILED DESCRIPTION

Embodiments of the invention include interactive apparatuses. An exemplary interactive apparatus comprises a stylus housing, a processor coupled to the stylus housing, a memory unit, and an audio output device. The processor is operatively coupled to the memory unit and the audio output device. In some embodiments, the memory unit can comprise (i) computer code for recognizing a graphic element created by the user using the stylus, (ii) computer code for playing an audio recitation of at least one menu item in a plurality of menu items after the graphic element is created by the user, and (iii) computer code for recognizing a user selection of a menu item from the plurality of menu items. Alternatively or additionally, the memory unit may comprise (i) computer code for recognizing a plurality of graphic elements created using a stylus, (ii) computer code for recognizing the selection of at least two of the graphic elements in a user defined sequence using the stylus, and (iii) computer code for playing at least one audio output that relates to the formed graphic elements. Preferably, the interactive apparatus is in the form of a self-contained stylus and the processor, memory unit, and the audio output device are in the stylus housing.

The interactive apparatus may be used to teach or learn about any suitable subject. For example, the interactive apparatuses can be preprogrammed to teach about subjects such as letters, numbers, math (e.g., addition, subtraction, multiplication, division, algebra, etc.), social studies, phonics, languages, history, etc.

In some embodiments, the interactive apparatus may scan substantially invisible codes on a sheet of paper. Interactive apparatuses of this type are described in U.S. patent application Ser. No. 60/456,053, filed Mar. 18, 2003, and Ser. No. 10/803,803 filed on Mar. 17, 2004, which are herein incorporated by reference in their entirety for all purposes. The interactive apparatus may include an optical emitter and an optical detector operatively coupled to the processor. The interactive apparatus can optically scan substantially invisible codes on an article having a surface having a plurality of positions. Different codes are respectively at the plurality of positions and may relate to the locations (e.g., the relative or absolute spatial coordinates) of the plurality of positions on the surface. A user may form graphic elements such as print elements at the positions and/or pre-printed print elements may exist at those positions.

A “graphic element” may include any suitable marking created by the user. If a marking is made on a sheet of paper, the graphic element may be a print element. The marking could alternatively be within an erasable writing medium such as a liquid crystal display. In such instances, the graphic elements may be virtual graphic elements. Suitable graphic elements include, but are not limited to symbols, indicia such as letters and/or numbers, characters, words, shapes, lines, etc. They can be regular or irregular in shape, and they are typically created using the stylus.

In some embodiments, the graphic elements can include a letter or number with a line circumscribing the letter or number. The line circumscribing the letter or number may be a circle, oval, square, polygon, etc. Such graphic elements appear to be like “buttons” that can be selected by the user, instead of ordinary letters and numbers. By creating a graphic element of this kind, the user can visually distinguish graphic elements such as functional icons from ordinary letters and numbers. Also, by creating graphic elements of this kind, the interactive apparatus may also be able to better distinguish functional or menu item type graphic elements from non-functional or non-menu item type graphic elements. For instance, a user may create a graphic element that is the letter “M” which has a circle around it to create an interactive “menu” icon. The interactive apparatus may be programmed to recognize an overlapping circle or square with the letter “M” in it as a functional graphic element as distinguished from the letter “M” in a word. Computer code for recognizing such functional graphic elements and distinguishing them from other non-functional graphic elements can reside in the memory unit in the interactive apparatus.

The processor can recognize the graphic elements and can identify the locations of those graphic elements so that the interactive apparatus can perform various operations. In these embodiments, the memory unit may comprise computer code for correlating any graphic elements produced by the user with their locations on the surface.

In some embodiments, the article can be a sheet of paper with or without pre-printed print elements. The sheet can have substantially invisible codes on them. The codes are “substantially invisible” to the eye of the user and may correspond to the absolute or relative locations of the print elements on the page. “Substantially invisible” also includes codes that are completely or slightly invisible to the user's eye. For example, if dot codes that are slightly invisible to the eye of a user are printed all over a sheet of paper, the sheet may appear to have a light gray shade when viewed at a normal viewing distance. In some cases, after the user scans the codes with the interactive apparatus, an audio output device in the interactive apparatus produces unique audio outputs (as opposed to indiscriminate audio outputs like beeping sounds) corresponding to graphic elements that are associated with the codes.

Preferably, the substantially invisible codes are embodied by dot patterns. Technologies that read visible or “subliminally” printed dot patterns exist and are commercially available. These printed dot patterns are substantially invisible to the eye of the user so that the codes that are present in the dot patterns are undetectable by the user's eyes in normal use (unlike normal bar codes). The dot patterns can be embodied by, for example, specific combinations of small and large dots that can represent ones and zeros as in a binary coding. The dot patterns can be printed with ink that is different than the ink that is used to print the print elements, so that the interactive apparatus can specifically read the dot patterns.

Anoto, a Swedish company, employs a technology that uses an algorithm to generate a pattern the enables a very large unique data space for non-conflicting use across a large set of documents. Their pattern, if fully printed, would cover 70 trillion 8.5″×11″ pages with unique recognition of any 2 cm square on any page. Paper containing the specific dot patterns is commercially available from Anoto. The following patents and patent applications are assigned to Anoto and describe this basic technology and are all herein incorporated by reference in their entirety for all purposes: U.S. Pat. No. 6,502,756, U.S. application Ser. No. 10/179,966, filed on Jun. 26, 2002, WO 01/95559, WO 01/71473, WO 01/75723, WO 01/26032, WO 01/75780, WO 01101670, WO 01/75773, WO 01/71475, WO 00/73983, and WO 01/16691.

In some embodiments, the dot patterns may be free of other types of data such as data representing markers for data blocks, audio data, and/or error detection data. As noted above, the processor in the interactive apparatus can determine the location of the stylus using a lookup table, and audio can be retrieved and played based on the location information. This has advantages. For example, compared to paper that has data for markers, audio, and error detection printed on it, embodiments of the invention need fewer dots, since data for markers, audio, and error detection need not be printed on the paper. By omitting, for example, audio data from a piece of paper, more space on the paper can be rendered interactive, since actual audio data need not occupy space on the paper. In addition, since computer code for audio is stored in the interactive apparatus in embodiments of the invention, it is less likely that the audio that is produced will be corrupted or altered by, for example, a crinkle or tear in the sheet of paper.

Although dot patterned codes are specifically described herein, other types of substantially invisible codes may be used in other embodiments of the invention. For example, infrared bar codes could be used if the bar codes are disposed in an array on an article. Illustratively, a sheet of paper may include a 100×100 array of substantially invisible bar codes, each code associated with a different x-y position on the sheet of paper. The relative or absolute locations of the bar codes in the array may be stored in the memory unit in the interactive apparatus.

As noted, in preferred embodiments, the substantially invisible codes may directly or indirectly relate to the locations of the plurality of positions and/or any print elements on the sheet. In some embodiments, the substantially invisible codes can directly relate to the locations of the plurality of positions on a sheet (or other article). In these embodiments, the locations of the different positions on the sheet may be provided by the codes themselves. For example, a first code at a first position may include code for the spatial coordinates (e.g., a particular x-y position) for the first position on the sheet, while a second code at a second position may code for the spatial coordinates of the second position on the sheet. Different graphic elements such as user-generated print elements can be at the different positions on the sheet. These print elements may be formed over the codes. For example, a first print element can be formed at the first position overlapping the first code. A second print element can be formed at the second position overlapping the second code. When a user forms the first print element, the scanning apparatus recognizes the formed first print element and substantially simultaneously scans the first code that is associated with the formed first print element. A processor in the interactive apparatus can determine the particular spatial coordinates of the first position and can correlate the first print element with the spatial coordinates. When the user forms the second print element, the scanning apparatus recognizes the formed second print element and substantially simultaneously scans the second code. A processor can then determine the spatial coordinates of the second position and can correlate the second print element with the spatial coordinates. A user can then subsequently select the user-formed first and second print elements using the interactive apparatus, and the interactive apparatus can perform additional operations. For example, as noted below, using this methodology, a user can create a user-defined interface or a functional device on a blank sheet of paper.

The interactive apparatus may also include a mechanism that maps or correlates relative or absolute locations with the formed graphic elements in the memory unit. The mechanism can be a lookup table that correlates data related to specific graphic elements on the article to particular locations on an article. This lookup table can be stored in the memory unit. The processor can use the lookup table to identify graphic elements at specific locations so that the processor can perform subsequent operations.

The article with the substantially invisible codes can be in any suitable form. For example, the article may be a single sheet of paper, a note pad, filler paper, a poster, a placard, a menu, a sticker, a tab, product packaging, a box, a trading card, a magnet (e.g., refrigerator magnets), etc. Any of these or other types of articles can be used with or without pre-printed print elements. If the article is a sheet, the sheet can be of any suitable size and can be made of any suitable material. For example, the sheet may be paper based, or may be a plastic film.

In some embodiments, the article may be a three-dimensional article with a three-dimensional surface. The three-dimensional surface may include a molded figure of a human body, animals (e.g., dinosaurs), vehicles, characters, or other figures.

As noted above, in some embodiments, the article is a sheet and the sheet may be free of pre-printed print elements such as printed letters or numbers (e.g., markings made before the user creates graphic elements on the sheet). In other embodiments, pre-printed print elements can be on the sheet (e.g., before the user creates graphic elements on the sheet). Pre-printed print elements can include numbers, icons, letters, circles, words, symbols, lines, etc. For example, embodiments of the invention can utilize pre-printed forms such as pre-printed order forms or voting ballots.

The interactive apparatus can be in any suitable form. In one embodiment, the interactive apparatus is a scanning apparatus that is shaped as a stylus, and is preferably pocket-sized. The stylus includes a stylus housing that can be made from plastic or metal. A gripping region may be present on the stylus housing. If the interactive apparatus is in the form of a portable, self-contained stylus, the interactive apparatus can weigh about 4 ounces, can have a battery life of about 40 hours, and can use a processor (e.g., including an ASIC chip) to control the functions of the interactive apparatus. The stylus may contain an earphone jack, a data port, flash memory, batteries, and an optical scanner (with an optical detector and an optical emitter) at the stylus tip, and a speaker. The stylus can resemble a pen at its lower half, and can flow broader at the top to rest comfortably between the user's thumb and forefinger.

In other embodiments, the interactive apparatus comprises a stylus and a platform (which may resemble a clipboard). The stylus is tethered to the platform and may contain a speaker, batteries, and flash/cartridge connector. The platform can clip to a sheet for convenience.

Although interactive apparatuses with optical emitters and optical detectors are described in detail, the interactive apparatuses may take other forms and need not include an optical emitter and an optical detector. For example, in some embodiments, the interactive apparatuses may be in the form of a tablet computer such as a tablet PC or a personal digital assistant (PDA) that uses a stylus. Such devices are commercially available. The memory unit in the tablet PC or PDA can have computer code for performing any of the functions described in this application. Graphic elements can be created in a liquid crystal display, and the user can thereafter interact with those created graphic elements in the manner described herein. In these embodiments, the stylus may or may not include active electronics. For example, the technology present in many PDAs can be used so that styluses without any electronics can be used in some embodiments of the invention. As will be explained in detail below, those of ordinary skill in the art can program the various inventive functions described herein into such commercially available devices.

In yet other embodiments, the interactive apparatuses can be of the type described in U.S. patent application Ser. No. 10/457,981, filed on Jun. 9, 2003, and U.S. patent application Ser. No. ______, entitled “Print Media Apparatus Including Handwriting Recognition” filed on May 28, 2004 (attorney docket no. 020824-009200US), which are incorporated herein by reference. In these embodiments, the interactive apparatus is an electrographic position location apparatus with a platform comprising a surface, a processor, a plurality of first antenna elements, and an audio output device such as a speaker. A stylus including a second antenna element and a writing instrument can be coupled to the platform. The first antenna elements may be signal transmitting antenna elements and the second antenna element may be a signal receiving antenna element (or vice-versa). A sheet of paper (without substantially invisible codes) can be present on the platform at a pre-defined position. The first antenna elements may transmit different signals (e.g., signals with different amplitudes) at different x-y positions on the surface (and therefore the sheet of paper) and these different signals can be received by the second antenna element in the stylus. A first antenna element and a second antenna element can thus be capacitively coupled together through the paper. Thus, when the user creates a graphic element on the sheet of paper, a processor can determine the position of the graphic element being created. As described in U.S. patent application Ser. No. ______, entitled “Print Media Apparatus Including Handwriting Recognition” filed on May 28, 2004 (attorney docket no. 020824-009200US) (which is herein incorporated by reference in its entirety), the processor can also determine what graphic element is being created using commercially available character recognition software. As is described therein, character recognition software is commercially available from Xpert Eye, Inc. of Sammamish, Wash. (www.experteye.com) and Vision Objects, Inc. of Paris, France. Software such as the type sold by these entities can be used in any of the interactive apparatuses described herein. When this software is used in an electrographic position location apparatus (or any other interactive apparatus embodiment described herein) that uses paper, the software is able to recognize graphic elements that are created by the user on that piece of paper. As will be apparent from the many examples below, by determining the graphic elements created by the user and determining the positions of those graphic elements, a number of useful functions can be performed by the interactive apparatus.

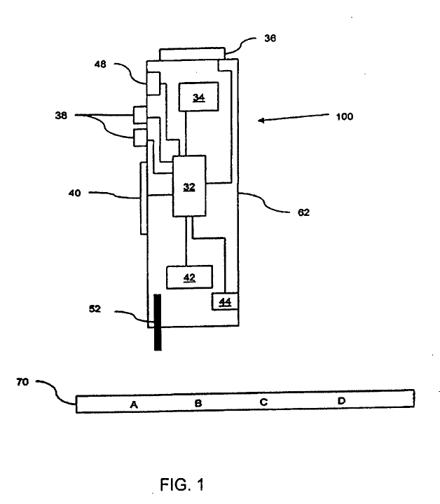

FIG. 1 shows a system according to an embodiment of the invention. The system includes an interactive apparatus 100 and an article 70. The interactive apparatus 100 is in the form of a stylus.

The interactive apparatus 100 includes a processor 32 inside of a stylus housing 62. The stylus housing 62 may be coupled, directly or through intervening physical structures, to the processor 32. The interactive apparatus 100 also includes an audio output device 36 and a display device 40 coupled to the processor 32. The audio output device 36 can include a speaker or an audio jack (an earphone or headphone jack). The display device 40 can include an LCD (liquid crystal display), or any other suitable display device. A device for providing tactile feedback (not shown) may also be present in the stylus housing 62.

In some embodiments, the display device 40 can be physically coupled to the stylus housing 62. In other embodiments, the display device 40 can be separated from the other parts of the interactive apparatus 100 and may communicate with the other parts by a wireless data transmission mechanism (e.g., an IR or infrared signal data transmission mechanism). Such separated display devices 40 can provide the user with the ability to see any visual feedback produced by his or her interaction with the interactive apparatus 100, and are suitable for classroom situations.

Input buttons 38 are also present and are electrically coupled to the processor 32 to allow a user to input information (such as start, stop, or enter) into the apparatus 100 and/or turn the apparatus 100 on and off. A power source 34 such as a battery is in the housing 62 and supplies electricity to the processor 32 and other components of the interactive apparatus 100.

An optical emitter 44 and an optical detector 42 are at one end of the stylus-shaped interactive apparatus 100. The optical emitter 44 and the optical detector 42 are coupled to the processor 32. The optical emitter 44 may be, for example, an LED (light emitting diode) or other light source, while the optical detector 42 may comprise, for example, a charge coupled device.

The processor 32 may include any suitable electronics to implement the functions of the interactive apparatus 32. For example, the processor 32 may include a microprocessor with speech synthesizing circuitry for producing synthesized speech, amplifier circuits for amplifying the speech, circuitry for controlling any inputs to the interactive apparatus 100 and any outputs provided by the interactive apparatus 100, as well as an analog-to-digital converter to convert signals received from the optical detector 42 into digital signals.

A memory unit 48 is also present in the interactive apparatus 100. The memory unit 48 is coupled to the processor 32. The memory unit 48 may be a removable memory unit such as a ROM or flash memory cartridge. In other embodiments, the memory unit 48 may comprise one or more memory units (e.g., RAM, ROM, EEPROM, etc.) that are completely internal to the housing 62. In other embodiments, the memory unit 48 may comprise the combination of two or more memory devices internal and/or external to the stylus housing 62.

The memory unit 48 may comprise any suitable magnetic, electronic, electromagnetic, optical or electro-optical data storage device. For example, one or more semiconductor-based devices can be in a memory unit 48.

The memory unit 48 comprises computer code for performing any of the functions of the interactive apparatus 100. For example, the memory unit 48 may comprise computer code for recognizing printed characters, computer code for recognizing a user's handwriting and interpreting the user's handwriting (e.g., handwriting character recognition software), computer code for correlating positions on an article with respective print elements, code for converting text to speech (e.g., a text to speech engine), computer code for reciting menu items, computer code for performing translations of language (English-to-foreign language dictionaries), etc. Software for converting text to speech is commercially available from a number of different vendors. The memory unit 48 may also comprise code for audio and visual outputs. For example, code for sound effects, code for saying words, code for lesson plans and instruction, code for questions, etc. may all be stored in the memory unit 48. Code for audio outputs such as these may be stored in a non-volatile memory (in a permanent or semi-permanent manner so that the data is retained even if the interactive apparatus is turned off), rather than on the article itself. Computer code for these and other functions described in the application can be included in the memory unit 48, and can be created using any suitable programming language including C, C++, etc.

A writing element 52 is at the same end of the stylus-shaped interactive apparatus 100 as the optical emitter 44 and the optical detector 42. The writing element 52 may comprise a marker, crayon, pen or pencil and may or may not be retractable. If it is retractable, then the writing element 52 may be coupled to an actuator. A user may actuate the actuator to cause the writing element to extend outward from or retract into the stylus housing. When it is used, a user can hold the stylus-shaped interactive apparatus 100 and use it to write on a sheet. The user's markings may also be scanned using the optical emitter 44 and the optical detector 42 and the processor 32 may interpret the user's writing.

The article 70 illustrated in FIG. 1 is two-dimensional and may be, for example, a sheet of paper. In FIG. 1, the letters A, B, C, and D represent different positions on the article 70. The different positions A, B, C, and D on the article 70 can have different codes (not shown) and different print elements (not shown). The codes and the print elements may overlap at positions A, B, C, and D. The different codes are substantially invisible to the eye of the user, and a user is unable to see the codes with the user's eyes in normal use.

Illustratively, the user may create a circled letter “M” on the article 70 with the writing element 52 in the interactive apparatus 100 to create a menu icon. The circled letter “M” (not shown in FIG. 1) is printed at position A over a substantially invisible code at position A. When the user selects and scans the letter “M” at a later time, the optical emitter 44 produces a light signal which is reflected off of the substantially invisible code at position A and is received by the optical detector 42. The processor 32 determines the location of the position A and retrieves audio that corresponds to the letter “M” from the memory unit 48 and/or performs a function related to the letter “M”. For example, after the interactive apparatus 100 is used to select the letter “M” and after it scans the substantially invisible code at position A, the processor 32 may shift the interactive apparatus 100 to a menu-interaction mode, whereby a user may scroll through the menu items and may select a menu item. The processor 32 may cause the audio output device 36 to produce a list of menu items for the user after each successive selection of the letter “M”. For instance, a first selection of the letter “M” with the interactive apparatus 100 may cause the audio output device 36 to recite “calculator”, a second selection of the letter “M” with the interactive apparatus 100 may cause the audio output device 36 to recite “translator”, etc. Each subsequent selection of the created graphic element can cause the interactive apparatus to recite a different menu item.

The writing element 52 can be used to write on a specific location on the article 70. Using appropriate handwriting recognition and/or optical character recognition software (which may be stored as computer code in the memory unit 48), a user's writing can be interpreted by the processor 32 so that the processor 32 can determine what the user wrote and also the particular location of the position where the user is writing. As explained in further detail below, using this information, the system and the interactive apparatus can be adapted to perform more complex operations such as language translations or mathematical operations.

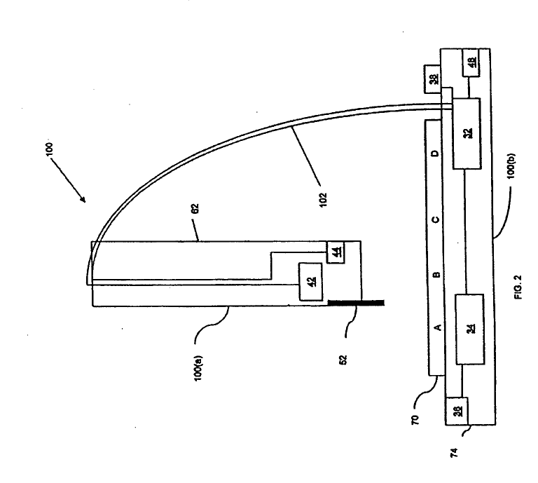

FIG. 2 shows another embodiment of the invention. In this example, like numerals designate like elements and the previous descriptions of like elements need not be repeated. However, in this embodiment, the interactive apparatus 100 includes a stylus 100(a) and a platform 100(b). A cable 102 couples the platform 100(b) to the stylus 100(a). The platform 100(b) supports the two-dimensional article 70. In this embodiment, the processor 32, the power source 34, the audio output device 36, buttons 38, and the memory unit 48 are in the platform 100(b) instead of the stylus 100(a). In other embodiments, it is possible to not have a cable and there can be a wireless link between the stylus 100(a) and the platform 100(b) (or other base unit).

In the embodiment shown in FIG. 2, there are fewer electronic components in the stylus 100(a), so that the stylus 100(a) can be made less bulky than the stylus-shaped interactive apparatus shown in FIG. 1. When the article being used is a sheet of paper, the sheet can be placed on the platform 100(b) to provide the sheet with support.

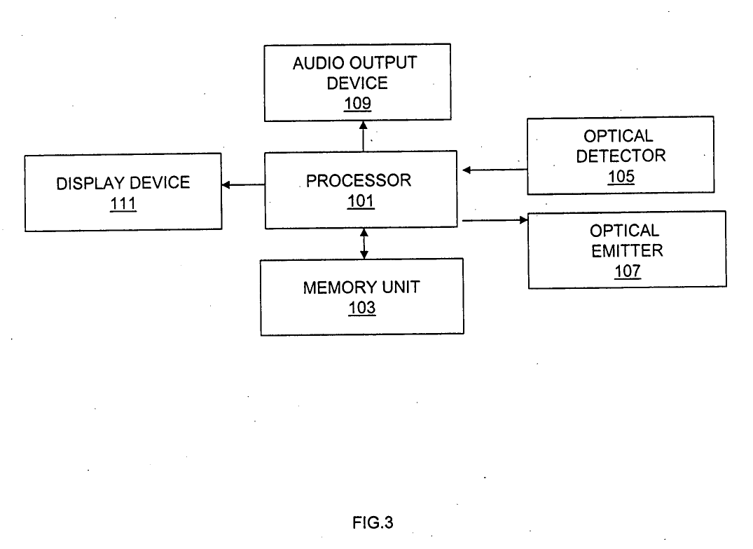

FIG. 3 shows a block diagram of some electrical components that can be used in a interactive apparatus according to an embodiment of the invention. The interactive apparatus may include a processor 101 and a memory unit 103 coupled to the processor 101. The processor 101 and the memory unit 103 may be embodied by one or more computer chips, alone, or in combination with one or more removable memory storage devices (e.g., memory sticks, memory cards, etc.). In some embodiments, the processor 101 may include an application specific circuit, and a speech synthesizer may be associated (e.g., within or coupled to the processor) with the processor 101. An optical detector 105 and an optical emitter are also operatively coupled to the processor 101. Output devices such as a display device 111 (e.g., an LCD or LED screen) and an audio output device 109 (e.g., a speaker or an earphone) may also be coupled to the processor 101. Additional exemplary details relating to these components are provided above and below.

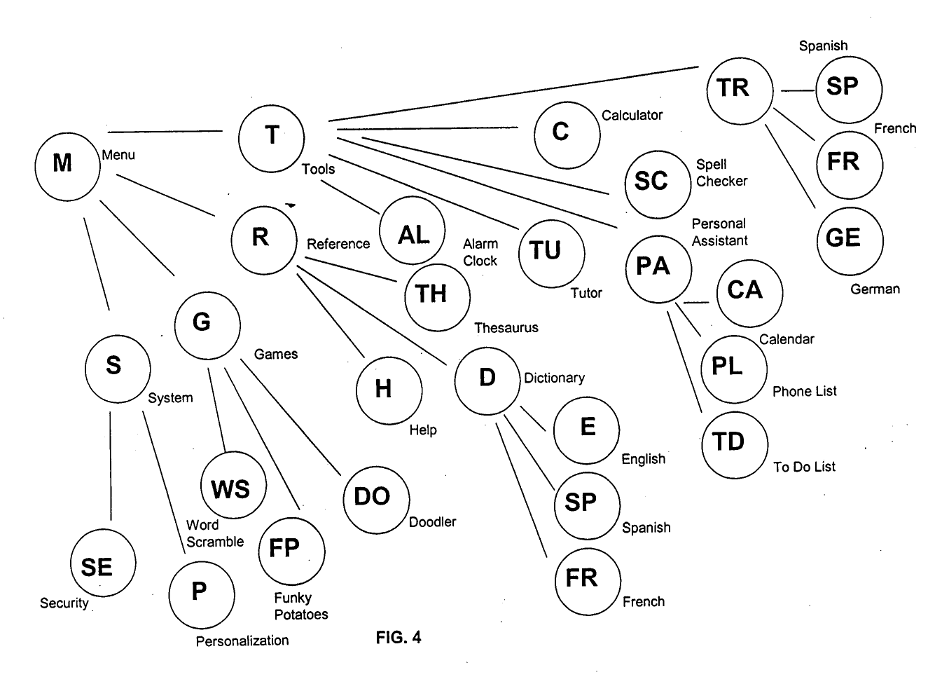

In embodiments of the invention, after the user creates a graphic element and the user subsequently selects that graphic element, a plurality of menu items may be presented to the user in audio form. The user may then select a menu item from the list of menu items. The menu items may include directory names, subdirectory names, application names, or names of specific data sets. Examples of directory or subdirectory names include, but are not limited to, “tools” (e.g., for interactive useful functions applicable under many different circumstances), “reference” (e.g., for reference materials such as dictionaries), “games” (e.g., for different games), etc. Examples of specific application (or subdirectory) names include “calculator”, “spell checker”, and “translator”. Specific examples of data sets may include a set of foreign words and their definitions, a phone list, a calendar, a to-do list, etc. Additional examples of menu items are shown in FIG. 4.

Specific audio instructions can be provided for the various menu items. For instance, after the user selects the “calculator” menu item, the interactive apparatus may instruct the user to draw the numbers 0-9, and the operators +, −, ×, /, and = on the sheet of paper and then select the numbers to perform a math calculation. In another example, after the user selects the “translator” menu item, the interactive apparatus can instruct the user to write the name of a second language and circle it. After the user does this, the interactive apparatus can further instruct the user to write down a word in English and then select circled second language to hear the written word translated into the second language. After doing so, the audio output device in the interactive apparatus may recite the word in the second language.

FIG. 4 shows a menu item tree directory according to an embodiment of the invention. The menu item tree directory can embody an audio menu starting from the menu M symbol.

Starting from the top of FIG. 4, a first audio subdirectory would be a tools T subdirectory. Under the tools T subdirectory, there could be a translator TR subdirectory, a calculator C subdirectory, a spell checker SC subdirectory, a personal assistant PA subdirectory, an alarm clock AL subdirectory, and a tutor TU function. Under the translator TR subdirectory, there would be Spanish SP, French FR, and German GE translator functions. Under the personal assistant PA subdirectory, there would be calendar C, phone list PL, and to do list TD functions or subdirectories.

Under the reference R subdirectory, there could be thesaurus TH function, a dictionary D subdirectory, and a help H function. Under the dictionary D subdirectory, there can be an English E function, a Spanish SP function, and a French FR function.

Under the games G subdirectory, there can be games such as word scramble WS, funky potatoes FP, and doodler DO. Other games could also be present in other embodiments of the invention.

Under the system S subdirectory, there can be a security SE function, and a personalization P function.

Details pertaining to some of the above directories, subdirectories, and functions are provided below.

As illustrated by the menu item tree-directory, a user may proceed down any desired path by listening to recitations of the various menu items and then selecting the menu item desired. The subsequent selection of the desired menu item may occur in any suitable manner.

For example, in some embodiments, a user can cause the interactive apparatus to scroll through the audio menu by “down touching” on a created graphic element. The “down touching” may be recognized by the electronics in the interactive apparatus using any suitable mechanism. For instance, the interactive apparatus may be programmed to recognize the image change associated with the downward movement of it towards the selected graphic element. In another example, a pressure sensitive switch may be provided in the interactive apparatus so that when the end of the interactive apparatus applies pressure to the paper, the pressure switch activates. This informs the interactive apparatus to scroll through the audio menu. For instance, after selecting the circled letter “M” with the interactive apparatus (to thereby cause the pressure switch in the interactive apparatus to activate), the audio output device in the interactive apparatus may recite “tools” and nothing more. The user may select the circled letter “M” a second time to cause the audio output device to recite the menu item “reference”. This can be repeated as often as desired to scroll through the audio menu. To select a particular menu item, the user can create a distinctive mark on the paper or provide a specific gesture with the scanning apparatus. For instance, the user may draw a “checkmark” (or other graphic element) next to the circled letter “M” after hearing the word “tools” to select the subdirectory “tools”. Using a method such as this, a user may navigate towards the intended directory, subdirectory, or function in the menu item tree. The creation of a different graphic element or a different gesture may be used to cause the interactive apparatus to scroll upward. Alternatively, buttons or other actuators may be provided in the interactive apparatus to scroll through the menu.

In other embodiments, after creating the letter “M” with a circle, the user may select the circled letter “M”. Software in the scanning apparatus recognizes the circled letter “M” as being the menu symbol and causes the scanning apparatus to recite the menu items “tools”, “reference”, “games”, and “system” sequentially and at spaced timing intervals, without down touching by the user. Audio instructions can be provided to the user. For example, the interactive apparatus may say “To select the ‘tools’ directory, write the letter ‘T’ and circle it.” To select the menu item, the user may create the letter “T” and circle it. This indicates to the interactive apparatus that the user has selected the subdirectory “tools”. Then, the interactive apparatus can recite the menu items under the “tools” directory for the user. Thus, it is possible to proceed directly to a particular directory, subdirectory, or function in the menu item tree by creating a graphic element representing that directory, subdirectory, or function on a sheet.

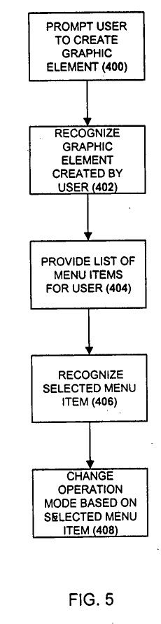

FIG. 5 shows a flowchart illustrating a method according to an embodiment of the invention. The method includes prompting a user to create a graphic element 400. The prompt may be an audio prompt produced by the interactive apparatus to the user to write a word, character, symbol, or other graphic element on a sheet of paper. The interactive apparatus recognizes the created graphic element 402, and the interactive apparatus recites a list of menu items for the user 404. The user then selects a menu item and the interactive apparatus recognizes the selected menu item 406, and changes its operation based on the selected menu item 408. The interactive apparatus can be programmed so that these steps can be performed and computer code for performing these steps can be present in the memory unit.

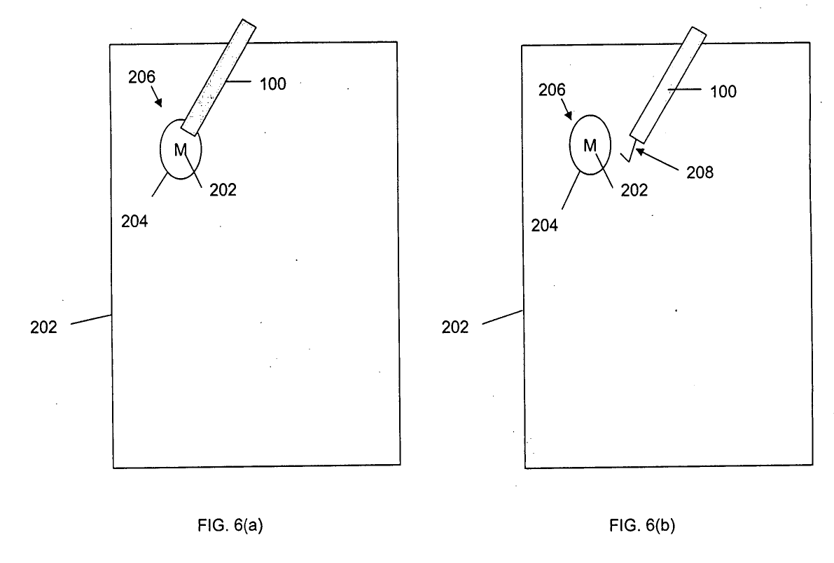

FIGS. 6(a) and 6(b) show illustrations of how a method according to the flowchart shown in FIG. 5 would work. First, an interactive apparatus 100 in the form of a self-contained stylus may prompt the user to create a graphic element (step 400). The user can then create one or more graphic elements on a sheet of paper 202. In this example, the graphic element 206 may include the letter “M” 202 with the circle 204 around the letter “M” 202. This graphic element 206 is drawn with a writing element (not shown) that is in the interactive apparatus 100.

After creating the graphic element 206, the interactive apparatus 100 may recite a number of menu items (step 404). For example, the interactive apparatus 100 may recognize that the user has finished writing the graphic element 206 with the letter M 202 and a circle 202 around it. As noted above, the interactive apparatus 100 may have optical character recognition software in it, and the apparatus 100 may be programmed to recognize that an overlapping letter “O” and letter “M” (i.e., within the same general physical position) indicates that the user has activated the audio menu inside of the interactive apparatus 206 (step 406). The interactive apparatus 100 can also be programmed so that each subdirectory name is recited after the user uses the interactive apparatus 100 to reselect the graphic element 206. For example, a four consecutive “down touches” on the graphic element 206 with the interactive apparatus 100 would cause the interactive apparatus 100 to respectively recite the subdirectory names “tools”, “reference”, “games”, and “system”.

To indicate a selection of a particular menu item, directory, or subdirectory, a user may create another graphic element or make a gesture with the interactive apparatus 100. For example, if the user wants to proceed down the “tools” subdirectory, for example, the user may then draw a checkmark 208 on the sheet 202 to indicate that a selection has been made. After drawing the checkmark, the words “calculator”, “spell checker”, “personal assistant”, and “tutor” can be recited by the interactive apparatus 100, after each subsequent selection or “down-touch” of the interactive apparatus 100 onto the sheet 202. The “calculator” function could then be selected after the user hears the word “calculator” recited to change the mode of operation of the interactive apparatus 100 to the calculator function (step 408). The user may draw another checkmark (not shown) on the sheet 202 to indicate that the user selected the calculator function.

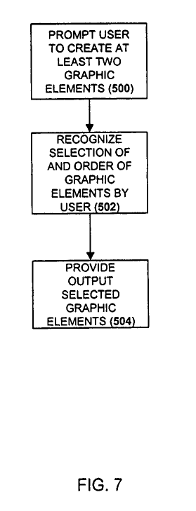

FIG. 7 shows a flowchart illustrating another embodiment of the invention. In this method, the interactive apparatus prompts the user to create at least two graphic elements (step 500). The interactive apparatus then recognizes the selection of and the order of the graphic elements by the user (step 502). Then, the interactive apparatus provides at least one output that relates to the selected graphic elements (step 504).

The at least one output can relate to the selected graphic elements in any way. For example, at least one output may include one or more sounds that are related to the content of the graphic elements. For example, in the calculator example below, two numbers such as 1 and 4 may be written on a sheet of paper. A user can then select them to add them together. The audio output “five” may be provided by the interactive apparatus, and may be related to the selected graphic elements 1 and 4. In another example, as will be shown in the word scramble game described below, circles may be drawn on a sheet of paper and words (not written on the paper) may associated with the circles. When the user selects those circles in a particular order, a sequence of words corresponding to the sequence of selected circles may sound from the interactive apparatus. The sounds provided by the interactive apparatus relate to the selected graphic elements, but do not necessarily relate to the content of the graphic elements.

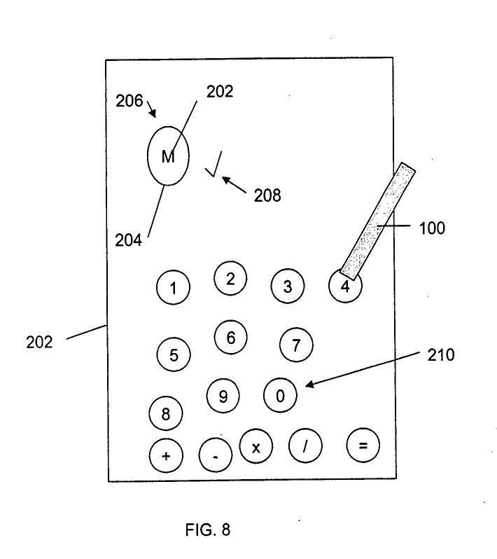

An example embodying the method shown in FIG. 7 is shown in FIG. 8. FIG. 8 shows how a user can create a paper calculator from a blank piece of paper. In this example, after the user has selected the “calculator” function as described above, the scanning apparatus prompts the user to write down the numbers 0-9 and the operators +, −, /, and = (step 500). A user creates the graphic elements 210 including numbers with circles around them, and mathematical operators for operations such as addition, subtraction, multiplication, division, and equals. In other embodiments, circles need not be provided around the numbers shown in FIG. 8. The interactive apparatus 100 recognizes the positions of the created graphic elements and recognizes the actual graphic elements created (step 502). A user can then select at least two graphic elements to receive an audio output related to the selection of those at least two graphic elements. For example, the user may select sequence of graphic elements “4” “+” “7” “=” to hear the interactive apparatus 100 recite “eleven” (step 504). The paper calculator can be re-used at a later time, since the interactive apparatus has stored the locations of the graphic elements in its memory unit. This embodiment can be useful in school where a student does not have a physical calculator available.

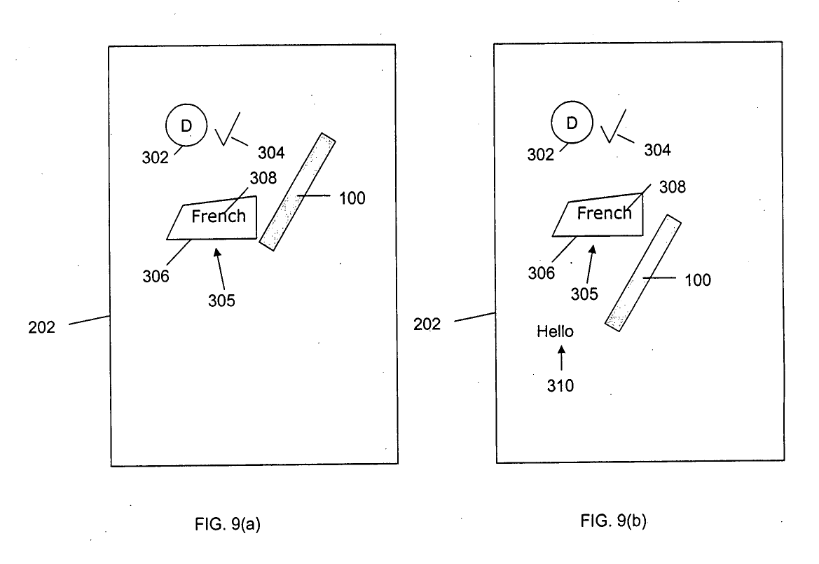

FIGS. 9(a) and 9(b) show another embodiment of the invention. Referring to FIG. 9(a), a user can write down the graphic element 302 D enclosed by a circle. After the interactive apparatus 100 recites the word “dictionary”, the user can create a checkmark 304 with the interactive apparatus 100 to indicate that the dictionary function is selected. After creating the graphic element 302, the interactive apparatus 100 may further prompt the user to create another graphic element 305 including the word “French” 308 enclosed by a line 306. The interactive apparatus 100 may then prompt the user to write a word and the user may write the word “Hello” 310 (step 500 in FIG. 7). The user may then select the word “Hello” and then the graphic element 305 to hear the word “Bon jour!” recited by interactive apparatus 100 (steps 50 and 506 in FIG. 7).

As illustrated by the foregoing example, the at least two graphic elements created by the user may comprise a first graphic element comprising a name of a language and a second graphic element comprising a word that is in a language that is different than the language. The user may select the word and then selecting the name of the language, and may then listen to at least one audio output including listening to a synthesized voice say the word in the language. The language can be a non-English language such as Spanish, French, German, Chinese, Japanese, etc., and the word can be in English. English-to-foreign language dictionaries may be stored as computer code in the memory unit of the interactive apparatus.

As illustrated in FIGS. 8 and 9, embodiments of the invention have a number of advantages. The circled letters and symbols resemble “buttons” that the user can interact with. The user can thereby create his or her custom user interface, essentially anywhere and at anytime. This provides for a convenient, interesting and fun way to interact with something that did not previously exist and that was created entirely by the user. This is unlike standard user interfaces such as standard keyboards.

Although a translator button is shown, a user can create other functional buttons on a sheet or other article. For example, other buttons might include help buttons, record buttons (if the interactive apparatus has a recorder and has recording capability), volume buttons, game buttons, etc. The user may also create alphanumeric keyboards with the interactive apparatus for data entry and subsequent interaction.

In some embodiments, the user can draw graphic elements and the user may interact with them in a playful and/or educational way. For instance, a user can draw the numbers 1 through 5 on a sheet of paper and the interactive apparatus can remember the location of each of them on the paper. The user may draw a “game” button to play a game. For example, the interactive apparatus may be programmed to prompt the user to find a number bigger than 2 and smaller than 5. The user may then try and guess what that number is by selecting one of the numbers. Correct or incorrect audio feedback may be provided to the user, in response to the user's selections.

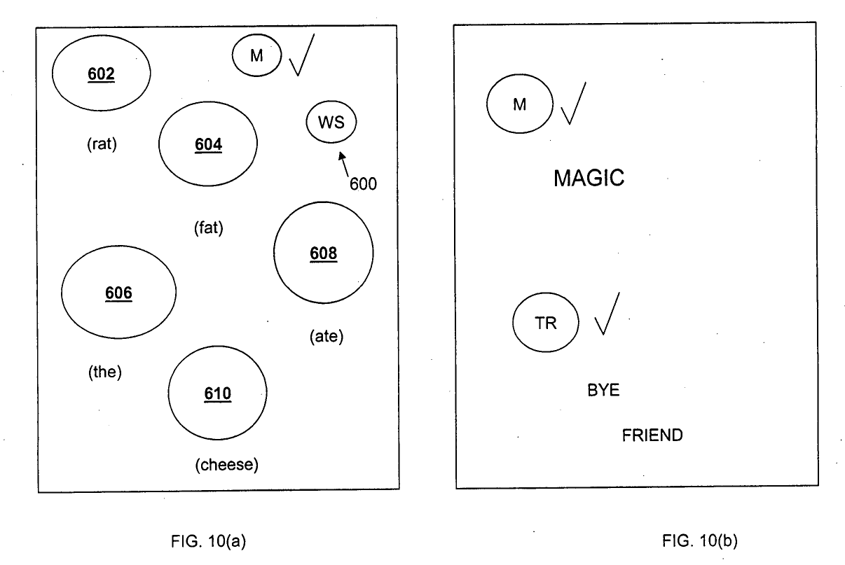

FIG. 10(a) shows a sheet with a number of circles 602, 604, 606, 608, 610 on it. They can be used in a game such as word scramble. For example, after creating the graphic element 600 (circled letters “WS” for word scramble), the interactive apparatus (not shown) may be placed in a word scramble mode. The interactive apparatus may ask the user to “Draw 5 SCRAMBLER circles” (step 500 in FIG. 7). After the user draws the 5 circles 602, 604, 606, 608, 610, audio segments (shown in parenthesis in FIG. 10(a)) are assigned to them. The user is then prompted to select the correct sequence of circles to produce a sentence. For example, the interactive apparatus may say, “Touch the SCRAMBLER circles in order to unscramble the sentence. Ready, GO!” The user may touch the 5 circles 602, 604, 606, 608, 610 in this order to produce the phrase “rat fat the ate cheese” (steps 502 and 504 in FIG. 7). Eventually, the user will figure out that the correct sequence of circles to be selected is circles 606, 604, 602, 608, 610 so that the interactive apparatus produces the sentence “The fat rat ate cheese.” (steps 502 and 504 in FIG. 7). At that point, a reward output may also be provided to the user for selecting the correct sequence of circles. The interactive apparatus may ask the user if the user wants to play again. Again, the interactive apparatus recognizes the graphic elements created by the user and correlates them with the locations on the sheet.

FIG. 10(b) shows another sheet with graphic elements. It can be used to illustrate a dictionary function and another way of performing a translator function. Referring to FIG. 10(b), a user first starts with a blank piece of paper and draws the circled letter M as shown. Then, the user uses the interactive apparatus (not shown) and “touches” the circled letter “M”. After the user hears the menu item “dictionary”, the user can draw a checkmark next to it to indicate that the dictionary menu item has been selected. The interactive apparatus then changes to a dictionary mode. The interactive apparatus may then prompt the user to “Write a word for its definition.” The user may then write the word “magic” as shown in FIG. 10(b). After writing the word “magic”, the interactive apparatus can recognize that “magic” was written and can say “Magic. It means the power to control natural forces or a power that seems mysterious.” The user may write down any suitable word and receive a dictionary definition.

After the user writes a word such as the word “magic”, the user may touch the last letter of the word (“c”) to tell the interactive apparatus that the user is done writing the intended word and that the interactive apparatus should produce the dictionary definition. Alternatively, the user may wait for a moment and a time-out mechanism in the interactive apparatus may cause the interactive apparatus to automatically produce the dictionary definition of the word “magic.” The former solution is preferred so that the user does not have to wait before receive the feedback desired. In this solution, a virtual box may be provided around the last character. If the user selects any region within this virtual box, this may indicate to the interactive apparatus that the user is done writing the intended word. For example, when the user touches the stylus down on last character, the user informs the stylus that the user is done writing. In one stylus embodiment, a pressure switch may be provided at the end of the stylus so that downward pressure forces the writing element upward. As noted above, the stylus may be programmed to recognize the written characters. If the pressure switch is activated, and written character is recognized again within a short period of time, then the stylus can determine that the sequence has been terminated and it can provide the intended feedback for the user. This methodology can be used with other sequences of characters such as sequences of numbers or sequences of symbols.

This solves a number of problems. First, by selecting the last character in a sequence, the user can quickly inform the stylus that the user is done writing. Selecting the last character of a sequence is a natural and efficient way to inform the stylus that the user is done writing and wants to receive feedback. Second, by selecting the last character, the stylus knows that the sequence is terminated and the scanning electronics in the stylus can be shut down. This saves battery power. Third, by selecting the last character of a sequence to indicate termination, at most, a dot is formed near the last character. This avoids clutter on the paper. Fourth, the last character of a sequence is a natural ending point for the user to request feedback. Its selection to indicate termination is intuitive to the user.

Referring again to FIG. 10(b), the user may then write down the circled letters TR for translator. After the user does this, the interactive apparatus may say, “Touch the TR for your translator menu.” Each down touch may cause the interactive apparatus to successively say “English-to-Spanish”, “English-to-French”, “English-to-German”, etc. If the user hears the “English-to-Spanish” option, the user may then draw a checkmark next to the circled TR. The user may then write “bye” and the interactive apparatus may say “Bye. Adios. A-d-i-o-s.” The user may then write “friend” and the interactive apparatus may say “Friend. El amigo. El (pause) a-m-i-g-o.”

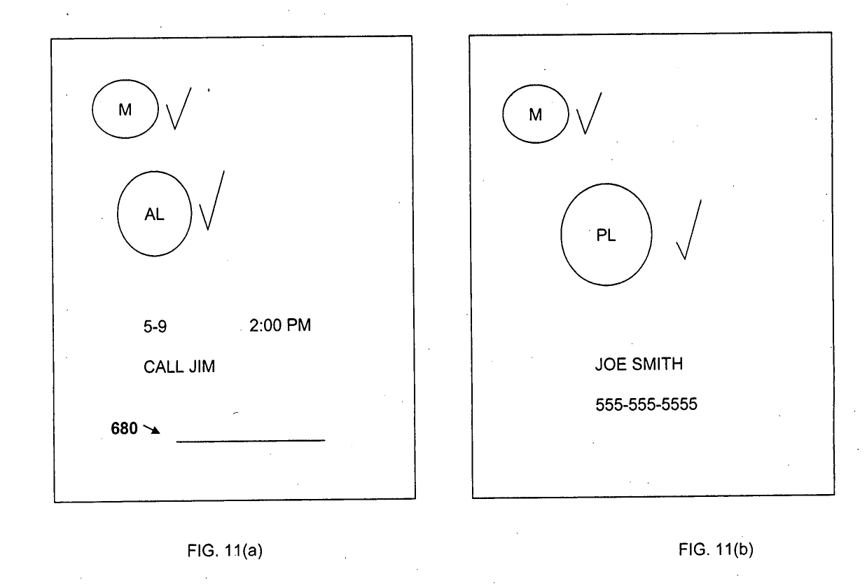

FIG. 11(a) shows how an alarm clock function can be used. The user may be prompted to create a circled “AL” or the user may know to this beforehand. This can occur after the user writes a circled letter M, hears a list of menu items, and selects the alarm clock function by drawing a checkmark near the letter M. The user then writes the letters AL and then circles them. The interactive apparatus then says “Alarm clock. Touch the AL for your alarm clock options.” Each successive down touch will cause the interactive apparatus to recite the functions “add alarm”, “review alarms”, and “current time” under the “alarm clock” subdirectory. To select, for example, “add alarm”, the user will create a checkmark next to the circled letters AL. The interactive apparatus may then prompt the user to “Write a date”. The user then writes “5-9” for May 9. Then, the interactive apparatus may prompt the user to “Write the time.” The user then writes “2:00 PM”. After writing the time, the interactive apparatus says “Now write the message.” The user then writes “Call Jim” and the interactive apparatus records this message. A text to speech software engine in the interactive apparatus then converts the message into spoken text and it says “Call Jim. Alarm set.” At 2:00 PM on 5-9, the interactive apparatus will automatically recite “Call Jim.”

In a review alarm mode, the user may draw a circled “RA” (not shown) for review alarm. Each successive touch will cause the interactive apparatus to say each successive alarmed message. For example, 3 successive touches of the letters RA will cause the interactive apparatus to play the next three messages (stored in the memory unit of the interactive apparatus) and the times and dates on which they will play.

FIG. 11(b) shows how a phone list function can be used. As shown, a user can write the circled letters PL after being prompted. This can occur after the user writes a circled letter M, hears a list of menu items, and selects the phone list function by drawing a checkmark near the letter M. The user can then touch the letters PL with the interactive apparatus. Each successive touch of the letters PL with the interactive apparatus causes the interactive apparatus to recite the functions “access a phone number”, “add a phone number”, and “delete a phone number” in the “phone list” subdirectory. The user may select “add a phone number” and may indicate this selection by drawing a checkmark next to the letters PL. The interactive apparatus may then prompt the user to “write a name” and the user writes the name “Joe Smith” with the interactive apparatus. Using a text-to-speech software engine, the interactive apparatus recites the name “Joe Smith”, and then prompts the user to “write the phone number”. The user then writes “555-555-5555” and the interactive apparatus recites this phone number to the user (using the text-to-speech software engine).

Joe Smith's phone number may be retrieved at a later time by accessing the “access a phone number” function in the “phone list” subdirectory, and then writing the name “Joe Smith”. After writing “Joe Smith”, this will be recognized by the interactive apparatus and the phone number for Joe Smith will be retrieved from the memory unit in the interactive apparatus and will be recited to the user through a speaker or an earphone in the interactive apparatus.

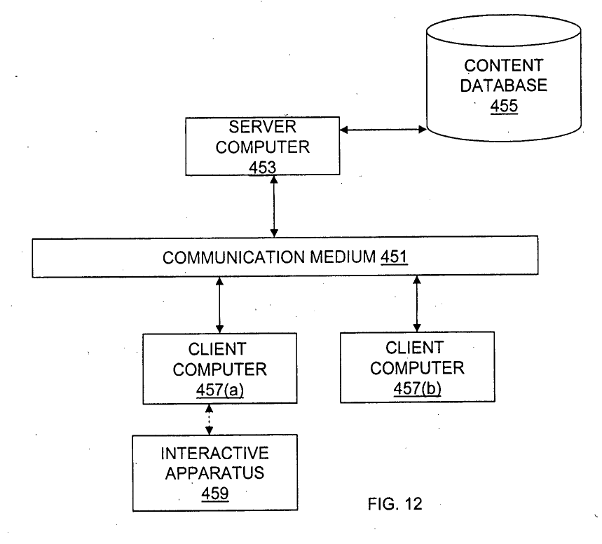

FIG. 12 shows a computer system that can be used to provide new and different content to the interactive apparatus. FIG. 12 shows a server computer 453 coupled to a database 455. The server computer 453 may operate a Website through which a user may contact to obtain new content. The database 455 may store new content for the interactive apparatus 459. The new content may comprise computer code for audio outputs, computer code for visual outputs, computer code for operating systems, etc. Although database 455 and server computer 453 are shown as two blocks, it is understood that a single computational apparatus or many computational apparatuses working together may embody them.

A communication medium 451 couples the server computer 453 and a plurality of client computers 457(a), 457(b). The client computers 457(a), 457(b) may be ordinary personal computers. The communication medium 451 may be any suitable communication network including the Internet or an intranet. Although two client computers are shown, there may be many client computers in embodiments of the invention.

The interactive apparatus 459 may be any of the interactive apparatuses described herein. The interactive apparatus 459 may communicate with the client computer 457(a) through any suitable connection including a wireless or wired connection. Through the client computer 457(a), the apparatus 459 may be in continuous or discontinuous communication with the server computer 453 via the communication medium 451. Suitable client computers include many commercially available personal computers.

Various descriptions of hardware and software are provided herein. It is understood that the skilled artisan knows of many different combinations of hardware and software that can be used to achieve the functions of the interactive apparatus described herein.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed.

Moreover, any one or more features of any embodiment of the invention may be combined with any one or more other features of any other embodiment of the invention, without departing from the scope of the invention. For example, any of the embodiments described with respect to FIGS. 4-11 can be used with the interactive apparatuses shown in either of FIGS. 1 or 2.

All references, patent applications, and patents mentioned above are herein incorporated by reference in their entirety for all purposes. None of them are admitted to be prior art to the presently claimed inventions.

1. A method comprising:
(a) a graphic element, the graphic element created by handheld device;
(b) generating an audio recitation of at least one menu item out of a plurality of menu items after recognition of the graphic element; and
(c) recognizing a selection of a menu item from the plurality of menu items upon a subsequent actuation of the handheld device, the actuation related to the graphic element.

2. The method of claim 1 wherein the handheld device is in the form of an interactive apparatus comprising a processor, an emitter, a detector, and a speaker, wherein the emitter, detector, and the speaker are operatively coupled to the processor.

3. The method of claim 1, wherein the graphic element is on a printable surface.

4. The method of claim 1 wherein the graphic element is a print element.

5. The method of claim 1 wherein the handheld device comprises an antenna.

6. The method of claims 3 wherein the printable surface is a sheet of paper.

7. The method of claim 1 wherein the graphic element includes a symbol.

8. The method of claim 1 wherein the graphic element includes a symbol and a line circumscribing the symbol.

9. The method of claim 1 wherein after recognition of the selection of the menu item, a speech synthesizer operatively associated with the handheld device audibly recites instructions for creating additional graphic elements.

10. The method of claim 1 wherein the plurality of menu items include at least one of calculator menu item, a reference menu item, and a games menu item.

11. An interactive apparatus comprising:
handheld device housing;
a processor coupled to the handheld device housing;
a memory unit comprising:
(i) computer code for recognizing a graphic element created by the handheld device;
(ii) computer code for playing an audio recitation of at least one menu item in a plurality of menu items after the graphic element is created by the user; and
(iii) computer code for recognizing a user selection of a menu item from the plurality of menu items; and
an audio output device, wherein the audio output device and the memory unit are operatively coupled to the processor.

12. The interactive apparatus of claim 11 wherein the processor, the audio output device, and the memory unit are in the handheld device housing.

13. The interactive apparatus of claim 11 wherein the processor, the audio output device and the memory are in a platform that is coupled to the handheld device housing.

14. The interactive apparatus of claim 11 wherein the processor, the memory unit, and the audio output device are all in the handheld device housing, and wherein the handheld device housing further comprises an optical emitter and an optical detector coupled to the processor.

15. The interactive apparatus of claim 11 wherein the graphic elements include letters or numbers.

16. The interactive apparatus of claim 11 wherein the memory unit comprises computer code for recognizing substantially invisible codes on an article.

17. The interactive apparatus of claim 11 wherein the memory unit comprises computer code for recognizing substantially invisible codes on an article, and wherein the substantially invisible codes are in the from of dot codes.

18. The interactive apparatus of claim 11 wherein the memory unit comprises computer code for recognizing substantially invisible codes on an article, and wherein the substantially invisible codes are in the from of dot codes that encode a relative or absolute position.

19. A system comprising:
(a) the interactive apparatus of claim 18; and
(b) an article including the substantially invisible codes.

20. A system comprising:
(a) the interactive apparatus of claim 18; and
(b) an article including the substantially invisible codes, wherein the article includes a sheet of paper.

21. A system comprising:
(a) the interactive apparatus of claim 18; and
(b) an article including the substantially invisible codes, wherein the article includes a sheet of paper that is free of any pre-printing.

22. A system comprising:
(a) the interactive apparatus of claim 18; and
(b) an article including the substantially invisible codes, wherein the article includes a sheet of paper that includes pre-printing.

23. A system comprising:
(a) an interactive apparatus comprising a stylus housing, a processor coupled to the stylus housing, a speech synthesizer, a memory unit comprising
(i) computer code for allowing a user to create a graphic element using the stylus,
(ii) computer code for playing an audio recitation of at least one menu item in a plurality of menu items after creating the graphic element,
(iii) computer code for allowing a user to select a menu item from the plurality of menu items, and
(iv) computer code for recognizing substantially invisible codes on an article, and wherein the substantially invisible codes are in the from of dot codes that encode a relative or absolute position, and an audio output device, wherein the speech synthesizer, the audio output device and the memory unit are operatively coupled to the processor, and wherein the speech synthesizer, the audio output device, the processor and the memory unit are in the stylus housing;

24. The system of claim 23 wherein the substantially invisible codes are dot codes.

25. The system of claim 23 wherein the memory unit comprises computer code for causing the interactive apparatus to recite the menu items after each sequential selection of the graphic element.

26. The system of claim 23 wherein the substantially invisible codes relate to the absolute positions on the article.

27. The system of claim 23 wherein the article includes a sheet of paper.

28. The system of claim 23 wherein the article includes a sheet of paper that is free of pre-printed print elements.

29. The system of claim 23 wherein the article includes a sheet of paper that includes pre-printed print elements.

30. The system of claim 23 wherein the graphic element includes one selected from the group consisting of at least one of indicium, and a combination of at least one indicium and a line circumscribing the at least one indicium.

31. A method comprising:
recognizing a plurality of created graphic elements on a surface:
recognizing a selection of at least one of the graphic elements, the selection implemented by a stylus upon an actuation of the stylus related to the at least one graphic element:
accessing a function related to the at least one graphic element:
providing at least one audio output in accordance with the function.

32. The method of claim 31 wherein the plurality of graphic elements comprise a plurality of numbers and mathematical operators, and wherein recognizing the selection comprises recognizing the selection of a first number, a first mathematical operator, a second number, and a second mathematical operator, wherein the first number, the first mathematical operator, and the second mathematical operator together form a math problem, and wherein the at least one audio output that relates to the selected first number, first mathematical operator, and the second mathematical operator comprises the answer to the math problem.

33. The method of claim 31 wherein the stylus comprises an emitter, a detector, a processor, and a speaker, wherein the emitter, detector, and the speaker are coupled to the processor.

34. The method of claim 31 wherein the stylus is coupled to a platform, which supports a sheet upon which the graphic elements are formed.

35. The method of claim 31 wherein the elements comprise letters.

36. The method of claim 31 wherein the elements comprise a first graphic element comprising a name of a language and a second graphic element comprising a word that is in a language that is different than the language, and wherein recognizing the selection includes recognizing the selection of the word and then recognizing the selection of the name of the language, and wherein to the at least one audio output includes a synthesized voice audibly rendering the word in the language.

37. The method of claim 31 wherein the graphic elements comprise a first graphic element comprising a name of a language and a second graphic element comprising a word that is in a language that is different than the language, and wherein recognizing the selection include recognizing the selection of the word and then recognizing the selection of the name of the language, and wherein the at least one audio output includes a synthesized voice audibly rendering the word in the language, wherein the language is a non-English language and wherein the word is in English.

38. The method of claim 31 wherein the stylus comprises a writing element, and wherein graphic elements are user created graphic elements on a sheet and are generated in conjunction with the stylus.

39. The method of claim 38 wherein the sheet includes a plurality of substantially invisible codes.

40. The method of claim 39 wherein the sheet is free of pre-printed print elements.

41. An interactive apparatus comprising:
a device housing;
a processor coupled to the device housing;
a memory unit comprising
(i) computer code for recognizing a plurality of graphic elements created using a device.
(ii) computer code for recognizing the selection of at least two of the graphic elements in a user defined sequence using the device, and
(iii) computer code for playing at least one audio output that relates to the formed graphic elements; and
an audio output device, wherein the audio output device and the memory unit are operatively coupled to the processor.

42. The interactive apparatus of claim 41 wherein the device comprises a writing element.

43. The interactive apparatus of claim 41 wherein the processor, the memory unit and the audio output device are in the device housing.

44. The interactive apparatus of claim 41 wherein the memory unit further comprises computer code for recognizing substantially invisible codes printed on an article.

45. The interactive apparatus of claim 41 wherein the memory unit further comprises computer code for recognizing substantially invisible codes printed on an article, wherein the substantially invisible codes comprise dot codes.

46. The interactive apparatus of claim 41 wherein the apparatus further comprises a platform and wherein the memory, the processor, and the audio output device are in the platform.

47. The interactive apparatus of claim 41 wherein the graphic elements comprise numbers and wherein the memory unit further comprises code for calculating numbers.

48. The interactive apparatus of claim 41 wherein the interactive apparatus comprises a writing element that is retractable.

49. The interactive apparatus of claim 41 wherein the memory unit further comprises computer code for teaching about at least one of letters, numbers, and phonics.

50. The interactive apparatus of claim 41 wherein the memory unit comprises computer code for causing a synthesized voice to recite a plurality of menu items.

51. A system comprising:
an interactive device comprising a device housing, a processor coupled to the device housing, a memory unit comprising
(i) computer code for recognizing a plurality of graphic elements created using the device.
(ii) computer code for recognizing the selection of at least two of the graphic elements in a user defined sequence using the device, and
(iii) computer code for playing at least one audio output that relates to the formed graphic elements, and an audio output device, wherein the audio output device and the memory unit are operatively coupled to the processors.

52. The system of claim 51 further comprising an article upon which the graphic elements are created.

53. The system of claim 52 wherein the article comprises a sheet of paper and wherein the sheet of paper includes a plurality of substantially invisible codes.

54. The system of claim 52 wherein the article comprises a sheet of paper and where[n the sheet of paper includes a plurality of substantially invisible codes comprising dot codes.

55. The system of claim 52 wherein the article comprises a sheet of paper and wherein the sheet of paper includes a plurality of substantially invisible codes wherein the substantially invisible codes include relative or absolute position information.

56. The system of claim 52 wherein the article comprises a sheet of paper and wherein the sheet of paper includes a plurality of substantially invisible codes, wherein the codes are dot codes, and wherein the sheet of paper is substantially free of pre-printed print elements.

57. The system of claim 51 wherein the processor, the audio output device, and the memory unit are in the device housing.

58. The system of claim 51 wherein the interactive device is in the form of a self-contained device.

59. The system of claim 51 wherein the memory unit comprises computer code for a plurality of menu items.

60. The system of claim 51 wherein the memory unit includes computer code for an English-foreign language dictionary.

61. A method for interpreting user commands, comprising:
recognizing a created graphical element on a surface;
accessing a function related to the graphical element;
providing an output in accordance with the function; and
associating the function with the graphical element.

62. The method of claim 61, wherein the output comprises an audio output related to the function.

63. The method of claim 61, further comprising:
enabling a subsequent access of the function in response to a subsequent selection of the graphical element by storing the association of the function with the graphical element.

64. The method of claim 63, wherein the storing of the association of the function with the graphical element implements a persistent availability of the function, for a predetermined amount of time, via interaction with the graphical element.

65. The method of claim 61, wherein the graphical element is created by a pen device on the surface.

66. The method of claim 65, wherein the surface comprises a sheet of paper.

67. The method of claim 61, further comprising:
accessing one of a plurality of functions related to the graphical element by interpreting at least one actuation of the graphical element, wherein the at least one actuation selects the one of the plurality of functions.

68. The method of claim 67, wherein the at least one actuation comprises recognizing at least one tap of the graphical element.

69. The method of claim 67, further comprising:
providing one of a plurality of audio outputs when the one of the plurality of functions is selected.

70. The method of claim 67, wherein the plurality of functions comprises a predetermined menu of options.

71. The method of claim 67, wherein the plurality of functions comprises a plurality of configuration options of an application related to the graphical element.

72. The method of claim 71, wherein at least one of the plurality of configuration options comprises a default configuration of the application.

73. The method of claim 71, further comprising:
implementing a hierarchy of functions; and
providing access to the hierarchy of functions via a corresponding hierarchy of graphical elements.

74. The method of claim 73, further comprising:
recognizing at least one actuation of the graphical element to select a first hierarchical level function;
prompting the creation of a second graphical element;
recognizing at least one actuation of the second graphical element to select a second hierarchical level function;
providing an audio output related to the second hierarchical level function; and
associating the second hierarchical level function with the second graphical element.

75. A method of interacting with a handheld device, said method comprising:
recognizing selection of a first graphical icon on a writable surface, said selection performed using a writing instrument of said handheld device;
in response to said selection, audibly rendering a listing of first options associated with said first graphical icon wherein said first options are operable to be invoked by said handheld device; and
in response to a selection of one of said first options, invoking said one of said first options.

76. A method as described in claim 75 wherein said first options comprise at least one application to be invoked.

77. A method as described in claim 75 wherein said one of said first options is an application program resident on said handheld device.

78. A method as described in claim 75 wherein said audibly rendering said listing of said first options comprises audibly rendering, one at a time, each of said first options in a round-robin fashion, in response to selections of said first graphical icon by said writing instrument.

79. A method as described in claim 78 further comprising identifying a selection of said one of said first options in response to said writing instrument selecting a portion of said first graphical icon after said one of said first options is audibly rendered.

80. A method as described in claim 79 wherein said portion of said first graphical icon is a symbol of a check mark.

81. A method as described in claim 79 wherein said selecting said portion comprises recognizing a gesture made by a user with said handheld device.

82. A method as described in claim 75 wherein said first graphical icon is user written on said surface and further comprising automatically identifying said first graphical icon and wherein said automatically identifying said first graphical icon is performed using a processor of said handheld device.

83. A method as described in claim 75 wherein said first graphical icon is pre-printed on said surface.

84. A method as described in claim 75 wherein said first graphical icon is a menu item and wherein said first options are submenu items within a hierarchy of options operable to be invoked by said handheld device.

85. A method as described in claim 75 wherein said first options comprise an option having an associated second graphical icon and further comprising:
recognizing selection of said second graphical icon on said writable surface, said selection performed using said writing instrument of said handheld device;
in response to said selection, audibly rendering a listing of second options associated with said second graphical icon wherein said second options are operable to be invoked by said handheld device; and
in response to a selection of one of said second options, invoking said one of said second options.

86. A method as described in claim 85 wherein said second options comprise at least one application to be invoked.

87. A method as described in claim 85 wherein said one of said second options is an application program resident on said handheld device.

88. A method as described in claim 85 wherein said audibly rendering said listing of said second options comprises audibly rendering, one at a time, each of said second options in a round-robin fashion, in response to selections of said second graphical icon by said writing instrument.

89. A method as described in claim 88 further comprising identifying selection of said one of said second options by responding to said writing instrument selecting a portion of said second graphical icon after said one of said second options is audibly rendered.

90. A method as described in claim 85 wherein said second graphical icon is user written on said surface and further comprising automatically identifying said second graphical icon and wherein said automatically identifying said second graphical icon is performed using a processor of said handheld device.

91. A method as described in claim 75 wherein said one of said first options comprises a text recognition function wherein said handheld device is configured to recognize the end of a written word by recognizing the user tapping the last character of the word.

92. A method as described in claim 75 wherein said one of said first options comprises a text recognition function wherein said handheld device is configured to recognize the end of a written word by recognizing the user drawing a box or circle around the word.

93. A method as described in claim 75 wherein said one of said first options comprises a dictionary function wherein said handheld device is configured to recognize a user written word and audibly render a definition related to said user written word.

94. A method as described in claim 75 wherein said one of said first options comprises a calculator function wherein said handheld device is configured to recognize a plurality of user written graphic elements, and wherein the plurality of graphic elements comprise a plurality of numbers and mathematical operators, and wherein said handheld device is configured to recognize the selection of a first number, a first mathematical operator, a second number, and a second mathematical operator, wherein the first number, the first mathematical operator, and the second mathematical operator together form a math problem, and audibly render at least one audio output that comprises the answer to the math problem.

95. A method as described in claim 75 wherein said one of said first options comprises a translator function wherein said handheld device is configured to recognize a plurality of user written graphic elements, and wherein a first graphic element comprises a name of a language and a second graphic element comprises a word that is in a language that is different than the language, and wherein said handheld device is configured to recognize the selection of the word and to recognize the selection of the name of the language and audibly render the word in the language.

96. A method as described in claim 75 wherein said one of said first options comprises a word scramble function wherein said handheld device is configured to recognize a plurality of user written graphic elements comprising words of a sentence, and wherein said handheld device is configured to recognize the sequential selection of the words and to audibly render the sentence upon a successful sequential selection of the words of the sentence.

97. A method as described in claim 75 wherein said one of said first options comprises an alarm clock function wherein said handheld device is configured to recognize a user written alarm time and audibly render an alarm related to said user written alarm time.

98. A method as described in claim 85 wherein said one of said first options comprises a phone list function, and wherein said audibly rendered listing of said second options comprises accessing a phone number, adding a phone number, or deleting a phone number, and in response to a selection of one of said second options, invoking said one of said second options of said phone list function.

99. A method as described in claim 75 wherein said handheld device comprises a processor in communication with a remote computer system external to the handheld device.

100. A method as described in claim 96 wherein said remote computer system is a server and said processor uses wireless communication to interact with said server.
